(19) United States
(12) Patent Application Publication
(10) Pub. No.: US 2013/0261282 A1
(43) Pub. Date: Oct. 3, 2013

(54) Process for Producing Polyamide Moldings From a Polymerizable Composition by Means of Rotomolding Processes

(71) Applicant: BASF SE, Ludwigshafen (DE)

(72) Inventors: Silke Biedasek, Mannheim (DE); Philippe Desbois, Edingen-Neckarhausen (DE)

(73) Assignee: BASF SE, Ludwigshafen (DE)

(21) Appl. No.: 13/850,697

(22) Filed: Mar. 26, 2013

Related U.S. Application Data
(60) Provisional application No. 61/615,918, filed on Mar. 27, 2012.

(51) Int. Cl. C08G 69/00; C08J 5/00

(52) U.S. Cl. CPC C08G 69/00; C08J 5/00
USPC 528/315; 264/311

(57) ABSTRACT

The present invention relates to a process for producing polyamide moldings by subjecting a lactam-containing polymerizable composition to a rotomolding process.

The present invention relates to a process for producing polyamide moldings by subjecting a lactam-containing polymerizable composition to a rotomolding process.

Once thermoset polymers, such as polyurethanes or polyesters, have hardened they cannot then alter their shape, unlike the thermoplastic polymers, for which the process of heating, deformation, and cooling is reversible. Among the thermoplastic polymers most frequently used in industry are not only the polyamides but also polyethylene, polypropylene, polycarbonate, etc.

Polyamides are currently in essence produced by condensation of dicarboxylic acids or derivatives of these with diamines or by ring-opening polymerization of lactams. There is also a process known in principle for producing polyamides by activated anionic lactam polymerization. For this, lactams such as caprolactam, laurolactam, piperidone, pyrrolidone, etc. are polymerized with ring-opening in a base-catalyzed anionic polymerization reaction. This is generally achieved by polymerizing, at elevated temperatures, a melt made of lactam and comprising an alkaline catalyst and what is known as an activator (or cocatalyst or initiator).

DE-A 14 20 241 by way of example describes anionic polymerization of lactams in the presence of potassium hydroxide as catalyst and with use of 1,6-bis(N,N-dibutyl-ureido)hexane as activator. Activated anionic lactam polymerization with use of sodium caprolactam is described by way of example in Polyamide, Kunststoff Handbuch [Polyamides, Plastics Handbook], Vol. 3/4, ISBN 3-446-16486-3, 1998, Carl Hanser Verlag, pp. 49-52 and Macromolecules, Vol. 32, No. 23 (1999), p. 7726.

The unpublished EP 11176950.1 and EP 11172731.9 describe solid particles which comprise a lactam, catalyst, and activator. This monomer composition can be used for producing polyamide by activated anionic polymerization. Said particles are produced by spray drying, optionally followed by a grinding procedure if agglomerates form. The unpublished EP 12151670.9 describes solid particles which can also comprise, alongside the lactam component, the catalyst, and activator, non-functionalized and/or hydroxy-terminated rubbers.

The prior art likewise says that the anionic polymerization of lactams during the molding of a polymer molding can take place in a reactive molding process or in a reaction injection molding process, where the catalyst and optionally other additives are added to the lactam melt during the process. Anionic polymerization of lactams in this type of reactive molding process or reaction injection molding process incurs considerable technical cost. Firstly, two-component systems have to be mixed prior to use. Further apparatuses are moreover required for producing a melt, for example mixing containers, mixing nozzles, etc., these having connection to the actual polymerization mold. When a melt is used it is not possible to prevent some onset of polymerization even before the melt has been introduced into the actual polymerization mold, and operations here therefore have to be followed by additional cleaning steps for the apparatuses used.

The production of polymer moldings from thermoplastic polymers is known from the prior art. The rotomolding process is a plastics-shaping process of this type. In this process, a raw material comprising polymer is charged to a mold support (rotomolding mold) and the mold support is heated, with biaxial rotation. The molten polymer here becomes uniformly distributed on the inner wall of the mold support. After a cooling phase, the finished polymer molding can be removed (Handbook of Thermoplastic Elastomers, Drobny, Jiri George, 2007, 108-121, William Andrew Publishing/Plastics Design Library).

The polymer moldings produced by rotomolding processes can be produced in a very wide variety of shapes. In comparison with the injection molding process, the rotomolding process provides a greater variety of shape. By way of example, the shape can be specified so as to provide easy incorporation of holes or cutouts into the polymer molding. This is also an advantage in comparison with the extrusion process. Rotomolding also permits production of moldings with low wall-thickness variation. However, the decisive advantage of the rotomolding process in comparison with the extrusion process or injection molding process is the possibility of highly cost-effective production of the moldings.

Rotational Molding Technology, Crawford, Roy J.; Throne, James L.; 2007; William Andrew Publishing/Plastics Design Library, p. 40 describes molding of polyamides, specifically polycaprolactam, by means of a rotomolding process.

U.S. Pat. No. 4,729,862 describes the production of a heat-stabilized polyamide composition made of polyamide and copper iodide. Said two components are mixed at 282° C. This mixture can then be subjected to a rotomolding process.

Rotomolding processes are mostly carried out by introducing polymers into the mold support and melting these, with rotation, in order to obtain the desired shape. This procedure is attended by some disadvantages. The mold support has to be heated to the melting point of the polymer, and very high temperatures are sometimes required here, depending on the polymer used. By way of example, temperatures >200° C. are generally required to convert PA6 to the liquid state. Despite this, formation of a homogeneous melt is not always ensured. This in turn leads to considerable qualitative shortcomings in the finished polyamide moldings. By way of example, it is not always possible to avoid the presence of unintended holes in the molding. Processing of PA6 is moreover made more difficult by high viscosity and brittleness. In order to obtain a uniformly distributed polymer melt in the rotomolding mold, an adequate rotation time is required. This can retard production of the moldings, making the process economically disadvantageous.

JP 7032390 describes the production of moldings by means of rotomolding, where an co-lactam is polymerized in the presence of an anionic polymerization catalyst and of an activator.

GB 1 133 840 describes the production of moldings, where lactams are polymerized in a hollow mold, with rotation. For this, an activated melt is first provided, and this is then transferred into the mold for the polymerization reaction.

IE 991090 describes a rotomolding process in which, inter alia, lactam and activator can be charged as premix to the mold.

U.S. Pat. No. 3,780,157 describes a process for the production of molded hollow bodies from polyamides via activated anionic polymerization of lactams by means of rotomolding processes, where the moldings have reinforcement by inorganic fillers, in particular by glass fibers. Although column 2, lines 60 to 67, says in very general terms that a powder mixture composed of the components lactam, catalyst, and activator can be introduced into the mold carrier, the specific examples reveal that an activated lactam melt is first provided, and that this is transferred in the molten state to the rotomolding mold.

EP 0755966 describes the production of composite materials from reinforcing fibers in a nylon-12 matrix which is composed of anionically polymerized laurolactam. Again in D2 an activated lactam12 melt is first produced, and is charged in the liquid state to a hot rotomolding mold. The melt is polymerized with exposure to pressure and temperature. However, D2 also discloses (page 4, lines 37/38) that powder mixtures made of lactam, catalyst, and cocatalyst can be used.

US 2007/0246475 describes the production and use of a polymerization composition composed of polymerization precursor, a catalyst, and an activator. The mixture is melted and, in the liquid state, charged to a rotomolding mold so that it can then be simultaneously subjected to polymerization and a rotomolding process. However, a disadvantage here is that the user not only has a further operation, namely the preparation of the melt from polymerization precursor, catalyst, and activator, but also requires further heatable mixing containers in addition to the rotomolding system. Separate storage and separate transport of the starting materials for the process for producing polyamide by activated anionic lactam polymerization incur high logistic cost. Similarly, separate introduction of the raw materials into the process for producing polyamide by activated anionic lactam polymerization is attended by high apparatus cost.

In addition, when two melt feeds, of which one comprises the activator and the other comprises the catalyst, have to be mixed with one another in order to provide the polymerizable composition it is not always possible to ensure stability with respect to polymerization. The melt feeds are mostly mixed or combined in-line or by way of an in-line mixer or a mixing nozzle. This gives a reactive mixture which is no longer stable with respect to polymerization, even before it has been transferred into a rotomolding mold. Once the reactive melt has been transferred into the rotomolding mold, additional cleaning of all of the apparatuses that have been in contact with the melt then follows, since otherwise the residual melt still present polymerizes, and this can lead to formation of deposits and in the worst case to blockage of the apparatuses.

Surprisingly, it has now been found that polyamide moldings can be produced by rotomolding processes by providing a solid, lactam-containing polymerizable composition and using same for simultaneous polymerization and shaping. This can not only eliminate the abovementioned disadvantages of the prior art for producing polyamide moldings but the process can also be carried out more efficiently in terms of time and of energy. It is advantageous that the material charged to the mold support, or with which the mold support is coated, is not directly the fully polymerized polyamide, but instead is a precursor liquefiable at low temperatures, and that the polymerization reaction is then carried out in-situ. This method can save not only time but also energy in the process, since the components for producing the molding generally have to be heated only once to a temperature above the melting point of the monomers.

Another advantage in respect of the economics of the process is that production of polyamide moldings can use a polymerizable composition which already comprises the lactam monomer, the catalyst, and the activator, and also optionally other additives, and which could be polymerized directly in the mold or on a support, e.g. a textile support, for example by increasing the temperature. Said polymerizable composition used in the invention can be charged in the solid state to a mold support (rotomolding mold), converted to a flowable liquid therein, distributed, and polymerized, to give a polyamide molding.

The resultant possibility of processing a single-component composition directly on customers' premises reduces the high logistic and apparatus cost incurred when the processes known from the prior art are used for producing polyamide moldings. It therefore becomes possible moreover to formulate a polymerizable composition in marketable form and transport stable precursors to the final customer who produces the moldings.

The invention provides a process for producing polyamide moldings, where:
(a) a polymerizable composition is provided which comprises
   A) at least one lactam,
   B) at least one catalyst, and
   C) at least one activator selected from isocyanates, anhydrides, acyl halides, reaction products of these with A), and mixtures of these,
(b) the polymerizable composition provided in step a) is charged in solid, flowable form to the mold support of a rotomolding system,
(c) the polymerizable composition in the mold support is heated, with rotation, to a temperature at which the polymerizable composition is a flowable liquid, and the flowable liquid polymerizable composition is distributed uniformly,
(d) the polymerizable composition is polymerized, with rotation,
(e) the polymerized composition is cooled, and
(f) the polyamide molding is removed from the mold support.

The present invention further provides the use of a polymerizable composition comprising at least components A, B, and C, in a rotomolding process for producing polyamide moldings.

A feature of the process of the invention in contrast to known processes of the prior art is at least one of the following points:
efficient use of time
efficient use of energy
low apparatus cost
high-quality polyamide moldings
low residual monomer content.

For the purposes of the present invention, the expression “polymerizable composition” means a composition which is solid at room temperature under standard conditions (20° C., 1013 mbar). It is preferable that the polymerizable composition used in the invention also remains solid at higher temperatures. The polymerizable composition used in the invention is preferably still solid at a temperature of at least 50° C., particularly preferably at a temperature of at least 60° C.

For the purposes of the invention, the expression “mold support” means a rotomolding mold.

For the purposes of the invention, the expression “melt” also denotes molten lactam with activator and catalyst dissolved therein. For the purposes of the present invention, the expression “melting” is not interpreted in a strict physicochemical sense, but is also used synonymously with conversion to a flowable liquid state.

For the purposes of the invention, the expression “biaxial rotation” denotes rotation around the vertical and the horizontal axis.

A polymer is “dimensionally stable” when it is no longer a flowable liquid.

Production of polyamides by activated anionic polymerization is known in principle. Preferred catalysts for the anionic polymerization reaction in the process of the invention are compounds which permit formation of lactam anions. The lactam anions per se can equally function as catalyst.

The polymerizable composition preferably takes the form of particles which in essence have the same composition, where each particle comprises components A), B), and C). For the purposes of the invention, “in essence the same composition” means that the composition of the particles is the same except for deviations resulting from a production process, for example those that usually occur during the weighing or metering of the components that form the particles. Each individual particle therefore comprises all of the components needed for the polymerization reaction. Particles which specifically do not have the same composition are those which comprise only exclusively one, or which comprise only exclusively two, of components A), B), and C). The polymerizable composition used in the form of particles in the invention therefore differs fundamentally from known dry-formulated polymerizable compositions (known as dry blends) of the prior art.

The average diameter of the particles is generally from 1 to 2000 μm, preferably from 10 to 1000 μm, particularly preferably from 50 to 500 μm, very particularly preferably from 100 to 200 μm. The average diameter here can be determined by light scattering or via sieve fractions, and is the volume-average diameter.

It is preferable to use a polymerizable composition which comprises, based on the total weight of the composition, from 50 to 99.7 parts by weight, preferably from 70 to 98 parts by weight, particularly preferably from 80 to 95 parts by weight, of at least one lactam (L). It is preferable to use a polymerizable composition which comprises, based on the total weight of the composition, from 0.2 to 16 parts by weight, preferably from 2.4 to 8 parts by weight, particularly preferably from 3.2 to 5.6 parts by weight, of at least one activator (A). It is preferable to use a polymerizable composition which comprises, based on the total weight of the composition, from 0.1 to 5.4 parts by weight, preferably from 0.54 to 3.6 parts by weight, particularly preferably from 0.64 to 3 parts by weight of at least one catalyst (C).

At room temperature, the polymerizable composition provided in step a) is stable and solid. In particular, the polymerizable composition used in the invention does not polymerize below the melting point of the lactam component and is therefore stable with respect to any undesired premature polymerization.

The polymerizable composition used in the invention can be stored for a plurality of months and used at any desired juncture for producing polyimide:

Particularly suitable lactams are ε-caprolactam, 2-piperidone (δ-valerolactam), 2-pyrrolidone (γ-butyrolactam), caprylolactam, enantholactam, laurolactam, and mixtures of these. Preference is given to caprolactam, laurolactam, and mixtures of these. It is particularly preferable to use, as lactam, exclusively caprolactam or exclusively laurolactam.

It is moreover also possible that the polymerizable composition comprises, in addition to at least one lactam, at least one monomer (M) copolymerizable therewith. The monomer (M) can in principle have been selected from lactones and crosslinking agents. The monomer has preferably been selected from lactones. Preferred lactones are by way of example ε-caprolactone and/or γ-butyrolactone. The amount of monomer (M) here should not exceed 40% by weight, based on the total weight of the monomers used for the polymerization reaction. It is preferable that the proportion of (M) is from 0 to 30% by weight, particularly from 0.1 to 20% by weight, based on total monomer. The polymerizable composition used in the invention can comprise a crosslinking monomer. A crosslinking monomer can be a compound which comprises more than one group which can be copolymerized with the lactam monomer. Examples of groups of this type are epoxy, amine, carboxy, anhydride, oxazoline, carbodiimide, urethane, isocyanate, and lactam groups. Examples of suitable crosslinking monomers are amino-substituted lactams, such as aminocaprolactam, aminopiperidone, aminopyrrolidone, aminocaprolactam, aminoenantholactam, aminolaurolactam, and mixtures of these, preferably aminocaprolactam, aminopyrrolidone, and mixtures of these, particularly preferably aminocaprolactam.

In one preferred embodiment of the invention, lactams exclusively are used as monomers.

Suitable catalysts (C) for use in the process of the invention are the catalysts commonly used, for example those usually used for anionic polymerization.

Catalysts of this type are known by way of example from Polyamide, Kunststoffhandbuch [Polyamides, Plastics Handbook], 1998, Karl Hanser Verlag. The catalyst (C) has preferably been selected from sodium caprolactamate, potassium caprolactamate, magnesium bromide caprolactamate, magnesium chloride caprolactamate, magnesium biscaprolactamate, sodium hydride, sodium, sodium hydroxide, sodium methanolate, sodium ethanolate, sodium propanolate, sodium butanolate, potassium hydride, potassium, potassium hydroxide, potassium methanolate, potassium ethanolate, potassium propanolate, potassium butanolate, and mixtures thereof.

In particular, a catalyst (C) is used which has been selected from sodium hydride, sodium and sodium caprolactamate. It is particularly preferable to use a catalyst (C) which has been selected from sodium caprolactamate. In one specific embodiment, a solution of sodium caprolactamate in caprolactam is used, e.g. Brüggolen® C10 from Brüggemann, DE, from 17 to 19% by weight of sodium caprolactamate in caprolactam. A catalyst (C) that is likewise particularly suitable is magnesium bromide caprolactamate, e.g. Brüggolen® C1 from Brüggemann, DE.

The molar ratio of Lactam (L) to catalyst (C) can vary widely, but is generally 1:1 to 10 000:1, preferably from 5:1 to 1000:1, particularly preferably from 1:1 to 500:1.

The polymerizable composition used in the invention comprises at least one activator (A) for anionic polymerization.

The term activator also covers precursors for activated N-substituted lactams of the type that, together with the lactam (L), form an activated lactam in situ. The number of growing chains depends on the amount of activator. Compounds generally suitable as activator (A) are isocyanates, anhydrides, and acyl halides, and reaction products of these with the lactam monomer.

Suitable activators (A) are inter alia aliphatic diisocyanates, such as butylene diisocyanate, hexamethylene diisocyanate, octamethylene diisocyanate, decamethylene diisocyanate, undecamethylene diisocyanate, dodecamethylene diisocyanate, methylenebis(cyclohexyl 4-isocyanate), isophorone diisocyanate, aromatic diisocyanates, such as tolylene diisocyanate, or methylenebis(phenyl 4-isocyanate), or polyisocyanates (e.g. isocyanates derived from hexamethylene diisocyanate; Basonat® HI 100/BASF SE), or allophanates (e.g. ethyl allophanate). In particular, mixtures of the compounds mentioned can be used as activator (A).

Other suitable activators (A) are aliphatic diacyl halides, such as butylenedioyl chloride, butylenedioyl bromide, hexamethylenedioyl chloride, hexamethylenedioyl bromide, octamethylenedioyl chloride, octamethylenedioyl bromide, decamethylenedioyl chloride, decamethylenedioyl bromide, dodecamethylenedioyl chloride, dodecamethylenedioyl bromide, 4,4′-methylenebis(cyclohexyloyl chloride), 4,4′-methylenebis(cyclohexyloyl bromide), isophoronedioyl chloride, isophoronedioyl bromide and also aromatic diacyl halides, such as tolylmethylenedioyl chloride, tolylmethylenedioyl bromide, 4,4′-methylenebis(phenyl) acyl chloride, 4,4′-methylenebis(phenyl) acyl bromide. In particular, mixtures of the compounds mentioned can be used as activator (A).

Particular preference is given to a polymerizable composition where, as activator (A), at least one compound from the group consisting of aliphatic diisocyanates, aromatic diisocyanates, polyisocyanates, aliphatic diacyl halides, and aromatic diacyl halides is used.

One preferred embodiment uses, as activator (A), at least one compound which has been selected from hexamethylene diisocyanate, isophorone diisocyanate, hexamethylenedioyl bromide, hexamethylenedioyl chloride, and mixtures of these. It is particularly preferable to use hexamethylene diisocyanate as activator (A).

The activator (A) can be used in solid form or in the form of solution. In particular, the activator (A) can be used in a form dissolved in caprolactam. An example of a suitable activator (A) is a caprolactam-capped hexamethylene 1,6-diisocyanate. A solution of a caprolactam-capped hexamethylene 1,6-diisocyanate in caprolactam is obtainable commercially as Brüggolen® C20 from Brüggemann, DE.

The molar ratio of lactam (L) to activator (A) can vary widely, but is generally from 1:1 to 10 000:1, preferably from 5:1 to 2000:1, particularly preferably from 20:1 to 1000:1.

The polymerization composition used in the invention can also comprise, alongside the abovementioned components A, B, and C, at least one further component selected from polymers, monomers, fillers and/or fibrous materials, and other additives.

The polymerizable composition can comprise one or more polymers. The polymer can in principle have been selected from polymers which are obtained in the polymerization of the composition polymerizable in the invention, polymers different therefrom, and polymer blends. The polymerizable compositions used in the invention comprise an amount of from 0 to 40% by weight, preferably from 0 to 20% by weight, particularly preferably from 0 to 10% by weight, based on the total weight of the polymerizable composition, of at least one polymer. When the polymerizable composition comprises at least one polymer, the amount thereof is then preferably at least 0.1% by weight, particularly preferably 0.5% by weight, based on the total weight of polymerizable composition. In a specific embodiment, the polymerizable composition comprises no polymer formed in the polymerization of the polymerizable composition used in the invention. In another specific embodiment, the polymerizable composition comprises no polymer.

The polymerizable composition can comprise one or more polymers, where these are preferably added in the form of a polymer to the composition. In a first embodiment, the added polymer comprises groups which are suitable for forming block and/or graft copolymers with the polymers formed from the lactam monomer. Examples of such groups are epoxy, amine, carboxy, anhydride, oxazoline, carbodiimide, urethane, isocyanate, and lactam groups.

In another embodiment, the polymerizable composition comprises at least one polymer selected from polystyrene, styrene copolymers, polyphenylene oxide ethers, polyolefins, polyesters, polyethers, polyetheramines, polymers derived from vinyl monomers, and mixtures of the polymers mentioned. In one preferred embodiment, the polymerizable composition comprises at least one polymer selected from styrene-acrylonitrile copolymers (SAN), acrylonitrile-butadiene-styrene copolymers (ABS), styrene-butadiene copolymers (SB), polyethylene (HTPE (high-temperature polyethylene), LTPE (low-temperature polyethylene)), polypropylene, poly-1-butene, polytetrafluoroethylene, polyethylene terephthalate (PET), polyamides, polyethylene glycol (PEG), polypropylene glycol, polyether sulfones (PESU or PES), polyvinyl chloride, polyvinylidene chlorides, polystyrene, impact-modified polystyrene, polyvinylcarbazole, polyvinyl acetate, polyvinyl alcohol, polyisobutylene, polybutadiene, polysulfone, and mixtures of these. These serve by way of example to improve the properties of the product, compatibilities of the components, and viscosity.

In one embodiment, the solid polymerizable composition comprises at least one filler material. For the purposes of the invention, the expression “filler material” is interpreted widely and comprises particulate fillers, fibrous materials, and any desired transitional forms. Particulate fillers can comprise a wide range of particle sizes, extending from dusts to coarse-grain particles. Filler material used can comprise organic or inorganic fillers and/or organic or inorganic fibrous materials. By way of example, it is possible to use inorganic fillers, such as kaolin, chalk, wollastonite, talc powder, calcium carbonate, silicates, titanium dioxide, zinc oxide, graphite, glass particles, e.g. glass beads, nanoscale fillers, such as carbon nanotubes (carbonanotubes, carbon black, nanoscale or other phyllosilicates, nanoscale aluminum oxide (Al₂O₃), nanoscale titanium dioxide (TiO₂), graphene, and nanoscale silicon dioxide (SiO₂).

It is moreover possible to use one or more fibrous materials. These have preferably been selected from known inorganic reinforcing fibers, such as boron fibers, glass fibers, carbon fibers, silica fibers, ceramic fibers, and basalt fibers; organic reinforcing fibers, such as aramid fibers, polyester fibers, nylon fibers, polyethylene fibers, and natural fibers, such as wood fibers, flax fibers, hemp fibers, and sisal fibers.

It is particularly preferable to use glass fibers, carbon fibers, aramid fibers, boron fibers, metal fibers, or potassium titanate fibers. Specifically, chopped glass fibers are used. The fibers mentioned are preferably used in the form of short fibers in the polymerizable composition. The average fiber length of these short fibers is preferably in the range from 0.1 to 0.4 mm. It is also possible to use fibrous materials in the form of long fibers or of a mixture of short and long fibers. However, it is then advantageous to use these by adding them directly to the mold support, as described hereinafter in more detail for laid fiber scrims or for fiber braids. Suitable fibers are then also those with an average fiber length in the range from 0.5 to 1 mm, and long fibers, the average fiber length of which is preferably above 1 mm, with preference in the range from 1 to 10 mm. For direct use in the mold support there is in principle no upper limit for the length of suitable fibers. By way of example, fiber length in laid fiber scrims or in fiber braids may be described as infinite.

In particular, it is also possible to use mixtures of the fillers and/or fibrous materials mentioned. It is particularly preferable to use, as filler and/or fibrous material, glass fibers and/or glass particles, in particular glass beads.

The polymerizable composition used in the invention preferably comprises from 25 to 90% by weight, in particular from 30 to 80% by weight, based on the total weight of the polymerizable composition, of at least one filler and/or fibrous material. In one specific embodiment, the polymerizable composition used in the invention comprises from 30 to 50% by weight, based on the total weight of the polymerizable composition, of at least one filler and/or fibrous material. In another specific embodiment, the polymerizable composition used in the invention comprises from 50 to 90% by weight, based on the total weight of the polymerizable composition, of at least one filler and/or fibrous material.

In one preferred embodiment, the polymerizable composition can comprise at least one further additive. The amount of the additives, based on the total weight of the polymerizable composition, is preferably from 0 to 5% by weight, preferably from 0 to 4% by weight, particularly preferably from 0 to 3.5% by weight. Examples of additives that can be added are stabilizers, such as copper salts, dyes, antistatic agents, release agents, antioxidants, light stabilizers, PVC stabilizers, lubricants, flame retardants, blowing agents, impact modifiers, nucleating agents, and combinations. If the polymerizable composition comprises at least one additive, the amount thereof is preferably at least 0.01% by weight, based on the total weight of the polymerizable composition, particularly preferably at least 0.1% by weight, based on the total weight of the polymerizable composition, in particular at least 0.5% by weight, based on the total weight of the polymerizable composition.

It is preferable that the polymerizable composition used in the invention comprises, as additive, an impact modifier. If a polymeric compound is used as impact modifier, this is then counted with the abovementioned polymers. In particular, a polydiene polymer (e.g. polybutadiene, polyisoprene) is used as impact modifier. These preferably comprise anhydride groups and/or epoxy groups. The glass transition temperature of the polydiene polymer is in particular below 0° C., preferably below −10° C., particularly preferably below −20° C. The production of the polydiene polymer can be based on a polydiene copolymer with polyacrylates, with polyethylene acrylates, and/or with polysiloxanes, and can use the familiar processes (e.g. emulsion polymerization, suspension polymerization, solution polymerization, or gas-phase polymerization).

The invention produces a polyamide molding by charging a polymerizable composition, as described above, in solid form to a mold support (rotomolding mold) of a rotomolding system. Suitable rotomolding systems are known per se.

In a preferred method of producing a polyamide molding, a polymerizable composition, as described above, is charged to a mold support which is heated prior to charging of the polymerizable composition. It is preferable that, on charging of the polymerizable composition used in the invention, the temperature of the mold support is an elevated temperature which is selected in accordance with the lactam used. When caprolactam is used as lactam component, the temperature of the mold support is preferably from 20 to 55° C.

In a preferred method for producing a polyamide molding, as described above, the mold support and/or the oven cavity which is the location of the mold support are sealed after the charging process. It is advantageous to minimize the content of components not involved in the production of the polyamide molding, specifically water, carbon dioxide, and/or oxygen. The components and apparatuses used should therefore be in essence free from water, carbon dioxide, and/or oxygen. It is preferable to use an inert gas atmosphere for storing the components used and/or during charging to the rotomolding apparatus and/or during polymerization. An example of a suitable inert gas is nitrogen or argon. In many cases there is no need for full inertization, and it is instead sufficient that the containers, molds, etc. used are blanketed with an inert gas.

The invention produces the polyamide molding in step c) by increasing the temperature of the mold support, in order that the polymerizable composition becomes a flowable liquid. The temperature here is selected in such a way as to produce a flowable liquid form of the polymerizable composition and to distribute this uniformly on the internal area of the mold support. The mold support is heated by the methods known to the person skilled in the art. This is preferably achieved in an oven, e.g. hot-air oven, which is usually gas-fired.

The polymerizable composition described above is heated to a temperature at which it is a liquid of sufficient flowability to become distributed within the mold support when subject to rotation. For conversion of the polymerizable composition to a flowable liquid state it is generally sufficient to heat this at least to the melting point of the pure lactam component. The heating, in step c), of the polymerizable composition used in the invention is preferably achieved at a temperature of from 1 to 20° C., particularly preferably from 3 to 15° C., in particular from 5 to 10° C., above the melting point of the lactam component used. The heating in step c) of the polymerizable composition used in the invention is achieved at a temperature which is preferably less than 180° C., particularly preferably less than 160° C., in particular less than 120° C., specifically preferably less than 90° C. The temperature selected in step c) depends on the selection of the lactam component in the polymerizable composition.

The invention produces a polyamide molding in step d) by distributing a polymerizable composition, as described above, in the flowable liquid state uniformly onto the internal areas of the mold support. The uniform distribution of the flowable liquid composition is dependent on the viscosity of the polymerizable composition. This is affected by way of example by the lactam component used, the activator, and catalyst. The uniform distribution of the flowable composition has preferably been concluded after from 1 to 60 min, particularly after from 2 to 30 min, in particular after from 3 to 15 min.

It is preferable that the conversion of the polymerizable composition used in the invention to the flowable liquid state is achieved with biaxial rotation of the mold support. It is likewise preferable that the distribution of the flowable polymerizable composition used in the invention is achieved with biaxial rotation of the mold support.

The invention produces a polyamide molding in step d) by polymerizing a polymerizable composition, as described above, after the polymerizable composition has been converted to a flowable liquid and has been distributed.

The invention produces a polyamide molding by polymerizing a polymerizable composition as described above in step d) by heating to a temperature above the polymerization temperature. The temperature here depends on the process parameters. It is preferable that the temperature is in the range from 50 to 200° C. It is particularly preferable that the temperature is in the range from 60 to 170° C. In particular, the temperature for the use of caprolactam as lactam component is in the range from 85 to 150° C.

It is preferable that the polymerization in step d) is carried out by increasing the temperature of the mold support with biaxial rotation.

In one embodiment, a polyamide molding is produced by polymerizing a polymerizable composition, as described above, and using a prolonged residence time of the flowable liquid polymerizable composition in the mold support.

The polymerization time of the polymerizable composition used in the invention depends on the temperature, and nature and concentration of the catalyst and of the activator. The polymerization of the polymerizable composition in step d) of the process of the invention is generally complete after from 1 to 60 min, preferably from 2 to 30 min. In the process of the invention, polymerization time is defined as the time which starts when the oven temperature reaches the selected polymerization temperature (final temperature) and which ends when cooling begins (=step e)).

The rotation rate of the mold support during conversion to a flowable liquid, the distribution procedure, and the polymerization reaction depends on the viscosity of the polymerizable composition. The rotation rate of the axes is generally in the range from 1 to 40 rpm (revolutions per minute), preferably in the range from 1 to 20 rpm.

It is generally advantageous to minimize contamination which could lead to termination of the anionic polymerization reaction, e.g. water, carbon dioxide and oxygen. All of the components used should therefore in particular be dry and free from oxygen and carbon dioxide. It is preferable that the polymerization reaction is carried out with substantial exclusion of oxygen, carbon dioxide, and water. In particular, the steps in the process of the invention are carried out with substantial exclusion of oxygen, carbon dioxide, and water.

It is preferable that there is an inert gas atmosphere in the mold support during conversion to a flowable liquid, the distribution of the flowable polymerizable composition, and the polymerization reaction. In particular, an inert gas atmosphere is present during the polymerization reaction. As stated above, full inertization is generally not necessary here, but instead it is possible to carry out individual steps a), b), c), d), and/or e), or all of these steps, of the process of the invention in the presence of an adequate amount of an inert gas.

The polymerization reaction with rotation in step d) is followed in the invention by cooling of the resultant polymerized composition (=step e)). For this, the molding is generally cooled to a temperature at which the polymerized composition is dimensionally stable. The mold support is cooled in step e) to a temperature which is preferably from 20 to 80° C., particularly preferably from 30 to 70° C., with particular preference from 50 to 70° C.

The cooling preferably takes place with biaxial rotation of the mold support. It is preferable that, for cooling, the mold support is removed from the oven cavity. It is preferable that the cooling of the mold support is achieved by bringing it into contact with a coolant, e.g. air or an air/water mixture, or by simple opening of the mold support. The cooling phase is dependent on the wall thickness of the polyamide molding produced.

The cooling process has concluded when the polyamide molding is dimensionally stable. This can then be removed from the mold support.

The present invention also provides a process for producing a polyamide molding as stated above, where the mold support comprises at least one filler and/or fibrous material.

In one preferred embodiment, the mold support comprises a woven fiber and/or a fiber network, for example a glassfiber mat and/or a glassfiber network.

It is moreover possible that a filler and/or fibrous material is charged together with the polymerizable composition to the mold support. The optionally added filler and/or fibrous material can be selected from the abovementioned fillers and/or fibrous materials.

With the aid of the process of the invention it is possible to produce polyamide moldings with high content of filler and/or of fibrous material. In particular, the content of filler and/or of fibrous material in the polyamide molding obtained by the process of the invention is in the range from 30 to 90% by weight, in particular from 30 to 80% by weight, preferably from 30 to 50% by weight, based on the total weight of polymerizable composition. In one specific embodiment, the content of filler and/or fibrous material in the polyamide molding is from 50 to 90% by weight, based on the total weight the polymerizable composition.

The polyamide moldings produced by the process of the invention can in particular be used as material for producing parts of automobile bodywork, e.g. passenger compartment or wheel surround, or automobile parts such as frame cladding or dashboards, and for the interior of passenger compartments. Other possible uses for the polyamide moldings are as inliners for tanks, gearwheels, housings, packaging films, and coatings.

In principle, polyamide moldings produced by the process of the invention are suitable for any housings for small electrical devices, such as cell phones, laptops, iPads, or generally plastics items intended to imitate metal.

The process of the invention for producing polyamide moldings by activated anionic lactam polymerization by means of rotomolding processes with use of a polymerizable composition as raw material features a number of advantages in comparison with the use of a melt or of a polymer powder.

The process of the invention for producing polyamide moldings by activated anionic lactam polymerization by means of rotomolding processes with use of a polymerizable composition as raw material features logistic advantages, e.g. easy storage of the raw materials, easy transport of the raw materials, and easy introduction of the raw materials into the process, when comparison is made with the use of melts.

The process of the invention for producing polyamide moldings by activated anionic lactam polymerization by means of rotomolding processes with use of a polymerizable composition as raw material is moreover characterized by the advantage that the polymerizable composition has a low melting point and the amount of time and energy required by the rotomolding process is therefore less than when polymer powder is used.

The process of the invention for producing polyamide moldings by activated anionic lactam polymerization by means of rotomolding processes with use of a polymerizable composition as raw material is moreover characterized by the advantage that the flowable liquid polymerizable composition has low viscosity, and therefore exhibits better flow behavior, apparent in better, more uniform, and faster distribution of the flowable liquid polymerizable composition in the mold support, when comparison is made with polymer powder.

The process of the invention for producing polyamide moldings by activated anionic lactam polymerization by means of rotomolding processes with use of a polymerizable composition as raw material is moreover characterized by the advantage that the polymers are produced in situ. Solidification of the polyamide molding is therefore faster than that of polymer powder, and specifically actually at a temperature below the melting point of the polyamide.

The process of the invention for producing polyamide moldings by activated anionic lactam polymerization by means of rotomolding processes with use of a polymerizable composition as raw material is moreover characterized by the advantage that a polymerizable composition in the solid state is added to a mold support (rotomolding mold) and, in a mold, can be converted to a flowable liquid, distributed, and polymerized in order to obtain a polyamide molding.

The process of the invention for producing polyamide moldings by activated anionic lactam polymerization by means of rotomolding processes with use of a polymerizable composition as raw material is moreover characterized by the advantage that, when comparison is made with the prior art, the rotomolding process can be carried out with an abbreviated heating phase (conversion to flowable liquid and distribution of the polymerizable composition) and an abbreviated cooling phase.

The process of the invention for producing polyamide moldings by activated anionic lactam polymerization by means of rotomolding processes with use of a polymerizable composition as raw material features high efficiency in terms of energy and of time.

The examples below provide further explanation of the invention. Said examples illustrate some aspects of the present invention, but are certainly not to be considered as restricting the scope of protection of this invention.

### EXAMPLES

### Production of a 150 L Container for Liquid

The inertized mold support is preheated to the temperature T_{mold}. The pulverulent polymerizable composition A is charged to the mold support by way of an inertized solids valve. At an oven temperature of T_{oven,1}, the mold support is rotated at the rotation rate x around the primary axis and at the rotation rate y around the secondary axis, for the time t₁. The oven temperature is raised to T_{oven,2}. During the heating procedure and after the target temperature T_{oven,2} has been reached, rotation of the mold support is continued in the same way for the time t₂. Once energy supply to the oven has been switched off, the mold support is cooled by way of method B and opened after the time t₃. The finished container for liquid is removed.

| Example | I | II | III |
|---|---|---|---|
| A | 83.35% caprolactam | 83.35% caprolactam | 96.2% caprolactam |
| | 5.10% Brüggolen ® C20 | 5.10% Brüggolen ® C20 | 1.6% Brüggolen ® C20 |
| | 11.55% Brüggolen ® C10 | 11.55% Brüggolen ® C10 | 2.2% Brüggolen ® C10 |
| B | ambient air | ambient air and | ambient air |
| | | water cooling | |
| T_{mold} | 55° C. | 55° C. | 50° C. |
| T_{oven, 1} | 140° C. | 85° C. | 100° C. |
| T_{oven, 2} | 140° C. | 130° C. | 140° C. |
| x | 6 | 6 | 6 |
| y | 2 | 2 | 2 |
| t₁ | 4 minutes | 10 minutes | 11 minutes |
| t₂ | 5 minutes | 7 minutes | 10 minutes |
| t₃ | 30 minutes | 15 minutes | 35 minutes |

| Example | IV | V | VI |
|---|---|---|---|
| A | 83.35% caprolactam | 83.25% caprolactam | 94.00% laurolactam |
| | 5.10% Brüggolen ® C20 | 5.10% Brüggolen ® C20 | 2.00% Brüggolen ® C20 |
| | 11.55% Brüggolen ® | 11.55% Brüggolen ® C10 | 4.00% Brüggolen ® C10 |
| | | 0.1% CuI / KI | |
| B | ambient air and | ambient air | ambient air and |
| | water cooling | | water cooling |
| T_{mold} | 60° C. | 55° C. | 140° C. |
| T_{oven, 1} | 140° C. | 140° C. | 160° C. |
| T_{oven, 2} | 140° C. | 140° C. | 167° C. |
| x | 6 | 6 | 6 |
| y | 2 | 2 | 2 |
| t₁ | 9 minutes | 4 minutes | 7 minutes |
| t₂ | 7 minutes | 5 minutes | 10 minutes |
| t₃ | 15 minutes | 30 minutes | 23 minutes |

Brüggolen ® C20 = N,N′-hexamethylenebis(carbamoyl-ε-caprolactam)
Brüggolen ® C10 = from 17 to 19% of sodium caprolactamate in caprolactam
Brüggolen ® C1 = caprolactam magnesium bromide

1-14. (canceled)

15. A process for producing polyamide moldings, which comprises
(a) providing a polymerizable composition which comprises
A) at least one lactam,
B) at least one catalyst, and
C) at least one activator selected from isocyanates, anhydrides, acyl halides, reaction products of these with A), and mixtures of these,
(b) charging the polymerizable composition provided in step a) in solid, flowable form to the mold support of a rotomolding system,
(c) heating the polymerizable composition in the mold support, with rotation, to a temperature at which the polymerizable composition is a flowable liquid, and the flowable liquid polymerizable composition is distributed uniformly,
(d) polymerizing the polymerizable composition, with rotation,
(e) cooling the polymerized composition, and
(f) removing the polyamide molding from the mold support.

16. The process according to claim 15, wherein the polymerizable composition takes the form of particles and where all of the particles in essence have the same composition, and each particle comprises components A), B), and C).

17. The process according to claim 15, wherein the temperature of the mold support when the polymerizable composition is charged in step b) is from 20 to 55° C.

18. The process according to claim 15, wherein the polymerizable composition is heated in step c) to a temperature of from 1 to 20° C., above the melting point of the lactam used.

19. The process according to claim 15, wherein the polymerizable composition is heated in step c) to a temperature of from 5 to 10° C., above the melting point of the lactam used.

20. The process according to claim 18, wherein step c) concludes after from 1 to 60 min.

21. The process according to claim 18, wherein step c) concludes after from 3 to 15 min.

22. The process according to claim 15, wherein the polymerizable composition is heated in step d) to a temperature of from 10 to 100° C., above the melting point of the lactam used.

23. The process according to claim 15, wherein the polymerizable composition is heated in step d) to a temperature of from 30 to 80° C., above the melting point of the lactam used.

24. The process according to claim 20, wherein step d) concludes after from 1 to 60 min.

25. The process according to claim 20, wherein step d) concludes after from 2 to 30 min.

26. The process according to claim 15, wherein, in step e), the mold support is cooled to a temperature of from 20 to 80° C.

27. The process according to claim 15, wherein, in step e), the mold support is cooled to a temperature of from 50 to 70° C.

28. The process according to claim 15, wherein the polymerizable composition comprises, based on the total weight of the composition:
from 50 to 99.7 parts by weight of at least one lactam A),
from 0.1 to 3.6 parts by weight of at least one catalyst B), and
from 0.2 to 8.0 parts by weight of at least one activator C).

29. The process according to claim 15, where the polymerizable composition comprises at least one lactam A) selected from the group consisting of ε-caprolactam, 2-piperidone, 2-pyrrolidone, caprylolactam, enantholactam, laurolactam, and mixtures of these.

30. The process according to claim 15, wherein the polymerizable composition comprises at least one catalyst B), selected from the group consisting of sodium caprolactamate, potassium caprolactamate, magnesium bromide caprolactamate, magnesium chloride caprolactamate, magnesium biscaprolactamate, sodium hydride, sodium, sodium hydroxide, sodium methanolate, sodium ethanolate, sodium propanolate, sodium butanolate, potassium hydride, potassium, potassium hydroxide, potassium methanolate, potassium ethanolate, potassium propanolate, potassium butanolate, and mixtures thereof.

31. The process according to claim 15, wherein the polymerizable composition comprises at least one activator C) selected from the group consisting of hexamethylene diisocyanate, isophorone diisocyanate, hexamethylenedioyl bromide, hexamethylenedioyl chloride and mixtures of these.

32. The process according to claim 15, where the polymerizable composition takes the form of particles with an average diameter in the range from 1 to 2000 μm.

33. The process according to claim 15, where the polymerizable composition takes the form of particles with an average diameter in the range from 100 to 200 μm.

34. The use of a polymerizable composition comprising components, A, B, and C, as defined in claim 15, for producing polyamide moldings by a rotomolding process.
